(19) United States
(12) Patent Application Publication
(10) Pub. No.: US 2015/0161067 A1
(43) Pub. Date: Jun. 11, 2015

(54) REDUCED-AREA ARCHITECTURE FOR ASYMMETRIC INTERCONNECT

(71) Applicant: QUALCOMM Incorporated, San Diego, CA (US)

(72) Inventors: Kevin Robert BOWLES, Mission Viejo, CA (US); Hari Madhava RAO, San Diego, CA (US); Sei Seung YOON, San Diego, CA (US)

(73) Assignee: QUALCOMM Incorporated, San Diego, CA (US)

(21) Appl. No.: 14/099,786

(22) Filed: Dec. 6, 2013

(51) Int. Cl. G06F 13/40; G06F 13/16

(52) U.S. Cl. CPC G06F 13/4004; G06F 13/16

(57) ABSTRACT

A reduced-area interconnect allows client to client communication using an XBAR architecture. An XBAR compiler generates chip designs with XBAR data paths structured to reduce area and energy consumption. Tri-state buffers inserted into XBAR data paths are configured to direct data between clients and sources on a number of data paths corresponding to the lesser of the number of clients and the number of sources. Interface area and power consumption is reduced by eliminating paths that are not always being used.

### TECHNICAL FIELD

The present disclosure relates generally to an integrated circuit (IC) bus architecture. More specifically, one aspect of the present disclosure relates to a reduced-area, on-chip bus architecture for interconnecting selectable client circuitry with selected path segments.

### BACKGROUND

Integrated circuit bus architectures interconnect multiple client subsystems in an N×M configuration in which each member of a set of M source clients may be selectively coupled to each of a set of N destination clients on a bus. Multiplexing circuitry can provide a direct connection between selected clients and allows traffic to be forwarded from one client to a number of other clients simultaneously. Complex bus arbitration algorithms are commonly used to allow any source client to write to the bus and any destination client to read from the bus.

A particular crossbar switching configuration, referred to as XBAR, is becoming increasingly important to implement client to client connectivity in high speed circuitry such as modem and graphics processing circuitry. The operation of XBAR at high frequencies generally involves the use of repeaters and latch repeaters that increase dynamic power consumption.

XBAR configurations may be implemented without channels using standard place and route (P&R) flow techniques. Such configurations consume a large amount of dynamic power, increase congestion and operate at relatively low speeds. Such configurations also consume a large area on a chip and present timing closure problems.

Asymmetrical XBAR architectures allow a number of source clients or subsystems to selectively access a different number of destination clients or subsystems. Each client may write to and read from the XBAR in an N-way communication scheme. N-way multiplexing is used to sample specific clients on a cycle by cycle basis. Multiplexer control circuitry determines which clients can write to the XBAR system and which clients can listen to the XBAR system. For asymmetrical in-out XBARs the READ client multiplexor (MUX) architecture implements a source bus for each source client. When the number of source clients is greater than the number of destination clients, the asymmetrical XBAR architecture includes more busses than can be used in a given cycle. Thus, some area on a chip is wasted, by busses that are unused during some cycles. The wasted area may be substantial in complex systems involving, for example, 128 bit and 256 bit memory interfaces.

### SUMMARY

One aspect of the present disclosure relates to a low-power interconnect that includes a number of paths coupling a number of selectable destination clients and a number of source clients. The number of the paths may correspond to a minimum of the number of selectable destination clients and the number of source clients. The low-power interconnect also includes a number of tri-state devices coupled between the source clients and the paths. The tri-state buffers are configured to selectively allow data from the source clients onto the paths. Control circuitry is coupled to the tri-state devices and configured for control of the tri-state devices to establish connections between the destination clients and the source clients via the paths.

A memory interconnect according to an aspect of the present disclosure includes a first path coupled between a number of selectable data destinations and a first client. A number of tri-state buffers are configured in the first path between the selectable data destinations. Control circuitry is coupled to the tri-state buffers and configured to couple selected portions of the first path between selected data destinations of the selectable data destination.

A method for operating a memory interface according to aspects of the present disclosure includes receiving a first client select signal identifying a first client selectively coupled to the memory interface and coupling the first client to a first path in response to the first client select signal. The method also includes propagating the first client select signal to a first set of tri-state buffers between the first client and a second client on the first path. The method also includes turning on the first set of tri-state buffers in response to the first client select signal so that the first set of tri-state buffers couples the first client and the second client.

A memory interconnect according to another aspect of the present disclosure includes means for receiving a first client select signal identifying a first client selectively coupled to a memory interface. The memory interconnect also means for coupling the first client to a first path in response to the first client select signal. The memory interconnect further includes means for propagating the first client select signal to a first set of tri-state buffers between the first client and a second client on the first path. The memory interconnect also includes means for turning on the first set of tri-state buffers in response to the first client select signal so that the first set of tri-state buffers couples the first client and the second client.

Another aspect of the present disclosure includes a computer program product for operating a memory interface. The computer program product includes a non-transitory computer-readable medium having program code recorded thereon. The program code recorded on the non-transitory computer-readable medium includes program code to receive a first client select signal identifying a first client selectively coupled to a low-power interface and program code to couple the first client to a first path in response to the first client select signal. The program code recorded on the non-transitory computer readable medium also includes program code to propagate the first client select signal to a first set of tri-state buffers between the first client and a second client on the first path and program code to turn on the first set of tri-state buffers in response to the first client select signal so that the first set of tri-state buffers couples the first client and the second client.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1A is a schematic diagram conceptually illustrating a general example of XBAR interconnect circuitry.

FIG. 1B is a schematic diagram conceptually illustrating a portion of a an asymmetrical XBAR interconnect circuitry.

FIG. 1C is a schematic diagram conceptually illustrating a portion of an asymmetrical XBAR interconnect circuitry according to an aspect of the present disclosure.

FIG. 2 is a schematic diagram conceptually illustrating a general example of a reduced-area interconnect according to aspects of the present disclosure.

FIG. 3 is a process flow diagram illustrating a method for reducing area on an interconnect according to an aspect of the present disclosure.

FIG. 4 shows an exemplary wireless communication system in which an interface circuitry configuration may be advantageously employed according to the present disclosure.

FIG. 5 is a block diagram illustrating a design workstation for circuit, layout, and logic design of reduced-area interconnect circuitry according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

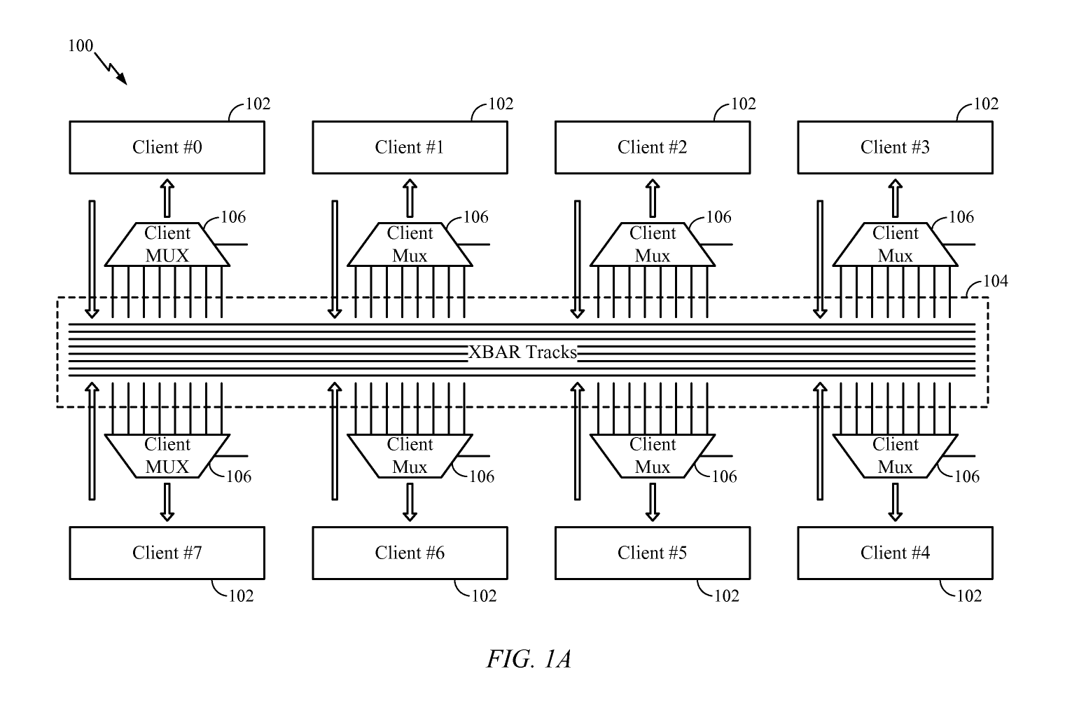

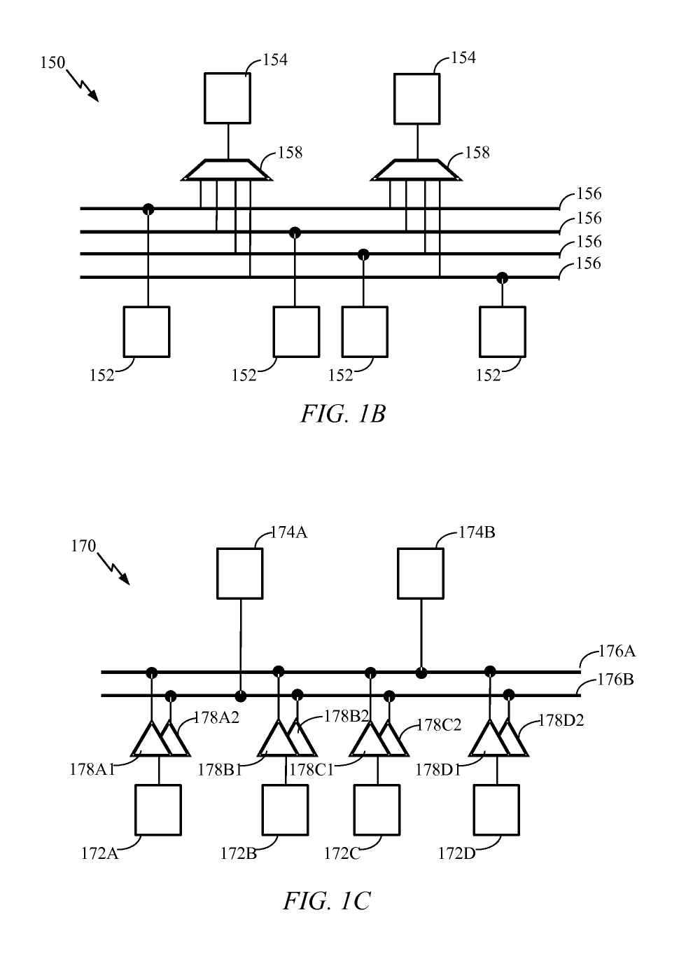

An interconnect that allows client to client communication using an XBAR architecture is described in FIG. 1A. The interconnect 100 includes a number (N) of clients 102 coupled to XBAR tracks 104 via multiplexer control circuitry 106, for example. The clients 102 may be various subsystems and modules such as, for example, separate processors and memories. In an asymmetrical XBAR architecture, in which a number of clients may write to or read from a different number of destinations or sources using an N-way communication scheme, a large amount of surface area on a chip may be wasted for routing of a source bus for each source client.

Standard XBAR implementation schemes are non-ideal when the number of input ports and the number of output ports of a dedicated XBAR are not equal. A portion of an asymmetrical XBAR architecture 150, which allows a number of source clients 152 or subsystems to selectively access a different number of destination clients 154 or subsystems according to a standard XBAR architecture is described with reference to FIG. 1B in which a number of XBAR tracks 156 is coupled between the source clients 152 and the destination clients 154. In this standard configuration, destination multiplexer circuitry 158 between the XBAR tracks and the destination clients selectively couples selected ones of the source clients 152 to selected destination clients. Control circuitry (not shown) coupled to the multiplexer circuitry controls the multiplexer circuitry. In this configuration, the number of XBAR tracks is based on the greater of the number of source clients 152 and the number of destination clients 154.

In such standard configurations, the area occupied by the XBAR architecture are sub-optimal. For example, if the number of input client ports exceeds the number of output client ports, a standard XBAR implementation includes more buses than are necessary for consumption by the destination clients. In other words, when the number of source clients is greater than the number of destination clients, the asymmetrical XBAR architecture includes more busses than can be used in a given cycle. Thus, some area on a chip is wasted, by busses that are unused during some cycles. The wasted area may be substantial in complex systems which may involve 128 bit or 256 bit memory interfaces, for example.

The maximum bandwidth at the interface of an asymmetrical XBAR (MxN) is determined by the lesser of the number of source clients or destination clients. According to aspects of the present disclosure, the interface area on a chip is reduced by routing interconnect resources based on the lesser number of the number of source clients or destination clients.

A portion of an asymmetrical XBAR architecture 170, which allows a number of source clients 172A-172D or subsystems to selectively access a different number of destination clients 174A and 174B or subsystems according to an aspect of the present disclosure is described with reference to FIG. 1C in which a number of XBAR tracks 176A-B is coupled between the source clients 172 and the destination clients 174. According to aspects of the present disclosure, the destination tri-state buffers 178 configured between the XBAR tracks 176 and the source clients selectively couples selected ones of the source clients 172 to selected destination clients. Control circuitry (not shown) coupled to the destination tri-state buffers 178 controls the destination tri-state buffers 178. In this configuration, according to aspects of the present disclosure the number of XBAR tracks 176 is based on the lesser of the number of source clients 172 and the number of destination clients 174. Although FIG. 1C shows a number of source clients 172 coupled to a lesser number of destination clients 174, it should be understood that in other configurations, according to aspects of the present disclosure, the number of destination clients may exceed the number of destination clients. In either case, according to aspects of the present disclosure, the number of XBAR tracks 176 equals or is based on the lesser of the number of source clients and the number of destination clients.

In each access cycle, the destination tri-state buffers 178 are controlled to selectively couple a selected one of the source clients 172 to a selected one of the destination clients 174. The control circuitry (not shown) may control the tri-state buffers based on a source tag identifying a source client and a destination tag identifying a destination client for each access cycle, for example. Control of the tri-state buffers may also be based on the direction of data in the access cycle, according to whether the access cycle is a read cycle or a write cycle, for example.

According to an aspect of the present disclosure, an on-chip interconnect architecture, such as an asymmetrical read/write XBAR architecture, includes multiple paths and an arrangement of tri-state devices to allow a member of a set of M source clients to be selectively connected to each of a set of N destination other clients on a bus.

One aspect of present disclosure reduces a memory interface area by decreasing the number of interface components used in an asymmetrical read/write interconnect architecture based on the lesser number of read/write interface clients coupled to the interface. A low-power interconnect, according to an aspect of the present disclosure includes a number of paths coupling a number of selectable destination clients and a number of source clients in which the number of paths corresponds to a minimum of the number of selectable destination clients and the number of source clients. According to an aspect of the disclosure, each path includes a number of tri-state devices coupled between the source clients and the paths. The tri-state devices are configured to map a path between a source client and a destination client and/or to selectively allow data from the source client onto the paths. The tri-state devices may also be configured to gate off non-selected portions of the paths. According to an aspect of the present disclosure control circuitry is coupled to the tri-state devices. The control circuitry is configured to control the tri-state devices to establish connections between the selectable destination clients and the source client via the paths.

According to aspects of the present disclosure, a tri-state capable bussing scheme is implemented as distributed multiplexor circuitry that reduces the size of an asymmetrical read/write interface bus, such as an asymmetrical read/write XBAR interconnect. The size and number of paths implemented in the tri-state capable bussing scheme is determined by the interface with the lowest number of clients.

According to aspects of the present disclosure, an XBAR compiler generates XBAR designs. XBAR compilers allow for rapid product development over a wide range of XBAR topologies. A user of the XBAR compiler may input design specifications, such as electrical specifications, frequency, orientation, layers, client information, and bus width, for example. An XBAR compiler can then generate a design including design views, such as, for example, verified electrical models for physical design integration, electrical models for top level integration, and place and route (P&R) flow for a chip. According to an aspect of the disclosure, the views generated by the XBAR compiler are compatible with existing application specific integrated circuit (ASIC) place and route flows.

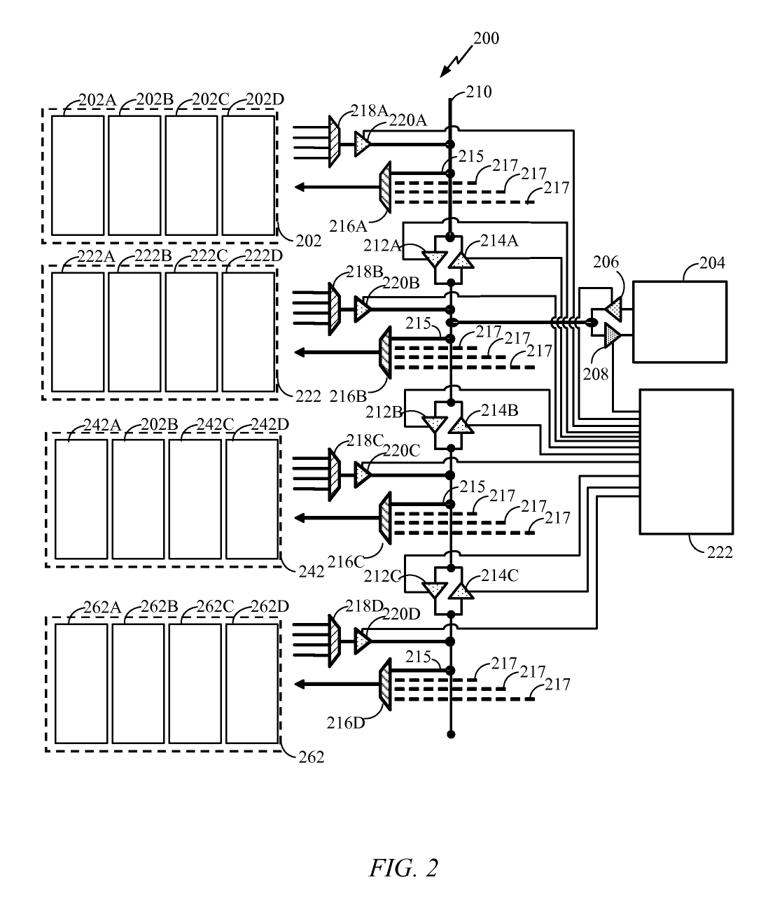

The XBAR compiler can generate chip designs with data paths structured to reduce area and energy consumption. Tri-state buffers are inserted into XBAR data paths to reduce the number of interface data paths. According to aspects of the present disclosure, the XBAR compiler may generate designs that reduce the number of data paths between a number of sources and a number of clients based on the lesser of the number of sources and the number of clients. According to one aspect of the present disclosure, tri-state buffers are inserted into the XBAR data paths, for example, as shown in FIG. 2.

Referring to FIG. 2, a reduced-area interconnect 200 may include a number of data sources, such as the source memory arrays 202, 222, 242, and 262 selectively coupled to a read/write client 204 over a single data path 210. It is understood that each additional read/write client would have its own data path connected to the source memory arrays. A write buffer 206 and a read buffer 208 are coupled between the read/write client 204 and a data path 210. Pairs of oppositely directed tri-state buffers 212A-212C, 214A-214C are coupled together in parallel to separate the data path 210 into several data path segments. Although the data path 210 and the data path segments are shown as single lines in FIG. 2, it should be understood that the data path 210 and data path segments may generally be multiple bits wide. Each of the data path segments is selectively coupled to a corresponding array of sources by first input 215 to a client selector multiplexor 216A-216D. Each additional input 217 to the client selector multiplexer is coupled to an additional data path (not shown) that may generally be configured and implemented in the same manner as the data path 210. Each one of the source memory arrays 202-262 includes a number of banks 202A-202D, 262A-262D respectively, coupled to corresponding inputs of a source selector multiplexor 218A-218D respectively. The source selector multiplexors 218A-218D are coupled to a corresponding data path segment by source branch tri-state buffers 220A-220D respectively. Control circuitry 222 is coupled to the source branch tri-state buffers 220 and the pairs of oppositely directed tri-state buffers 212, 214. The control circuitry selectively controls each tri-state buffer state by selecting between a high impedance off state, an on state, which passes data, and a bus-keeper state, which causes the tri-state buffer to drive its previous data state. The control circuitry 222 may also be coupled to the write buffer 206 and/or the read buffer 208 to selectively control their states.

According to an aspect of the present disclosure, the state of each of the tri-state buffers is controlled to direct data traffic so that one or more of the segments of data path 210 is used to interface the read/write client 204 to one or more second clients or data sources such as, for example, banks 202A-202D in a source memory array 202. In one example, a read cycle for reading data from a source memory array 202 to the read/write client 204 may be performed by turning on the source branch tri-state buffer 220A coupled to the data path segment corresponding to selected source 202 from which data is read. Each of the other ones of the source branch tri-state buffers 220B-220D coupled to each of the other data path segments is set to a high impedance off state to decouple the unselected source memory arrays 222-262 from the data path 210.

In one implementation of the read cycle, for illustrative purposes the selected one of the source memory arrays is the source memory array 202 shown in FIG. 2. In order to enable a path between the source memory array 202 and the read/write client 204, the pairs of oppositely directed ones of the tri-state buffers 212, 214 are controlled to turn on the tri-state buffers 212B-212C that are directed away from the selected source memory array 202 and to turn off all of the tri-state buffers 214B-214C that are directed toward the selected source memory array 202.

In another implementation of the read cycle in which the selected one of the source memory arrays is the source memory array 202 shown in FIG. 2, to enable the path between the source memory array 202 and the read/write client 204, some of the tri-state buffers 212 that are directed away from the source memory array 202 may be turned off (i.e. tri-stated, or in the bus-keeper state). For example, the downwardly directed one of the tri-state buffers 212B-212C that are not located between the selected one of the source memory arrays 202 and the read/write client 204 may be turned off. This implementation may save power by avoiding superfluous toggling of the tri-state buffers when driving of the data being read to data path segments beyond a particular destination client is unnecessary.

Although aspects of the present disclosure are described above in which the source memory array 202 is the selected one of the four illustrated ones of the source memory arrays 202-262, it should be understood that any number of source memory arrays 202-262 may be included in various implementations. Any of the numerous ones of the source memory arrays 202-262 or other clients may be selected for coupling to the read/write client 204.

In another example, a write cycle to write data from the read/write client 204 to a source memory array 202-262 may be performed by turning off the source branch tri-state buffers 220A-220D coupled to each of the data path segments. Turning off the source branch tri-state buffers 220A-220D decouples the read paths of each of the source memory arrays 202-262 from the data path 210. The pairs of oppositely directed tri-state buffers 212, 214 are controlled to turn on some or all of the tri-state buffers 212/214 that are directed away from read/write client 204. For example, in FIG. 2, to write from the read/write client 204 to the source memory array 202, the top upwardly directed tri-state buffer 214A is turned on and the top downwardly directed tri-state buffer 212A is turned off. In one implementation of the write cycle from the read/write client 204 to the top source memory array 202, the bottom two downwardly directed tri-state buffers 212B and 212C are turned on, and the bottom two upwardly directed tri-state buffers 214B and 214C are turned off. In this implementation, selection of the top source memory array 202 may be controlled by enabling only the client selector multiplexor 216A coupled to the top source array, while not enabling the client selector multiplexors 216B-216D coupled to the bottom three source memory arrays 222-262.

In another implementation of the write cycle, the data path segments that are not between the read/write client 204 and a source being written to may be decoupled by turning off pairs of oppositely directed tri-state buffers 214 that are not between the read/write client 204 and the source memory array 202-262 to which data is being written. For example, in a write cycle from read/write client 204 to the top source memory array 202 of FIG. 2, the data path segments that are not between the read/write client 204 and the top source memory array 202 may be decoupled by turning off pairs of oppositely directed tri-state buffers 214 that are not between the read/write client 204 and the top one of the source memory arrays 202.

In yet another implementation of the write cycle, the tri state buffers 212/214 that are directed away from the read/write client 204 and that are not between the read/write client 204 and the source memory array 202-262 to which data is being written may be placed in a bus-keeper state so as to drive their previous data state on segments not used by the write cycle.

Although specific circuitry has been set forth, it will be appreciated by those skilled in the art that not all of the disclosed circuitry is required to practice the disclosed configurations. Moreover, certain well known circuits have not been described, to maintain focus on the disclosure. Similarly, although upward and downward directions are described, the disclosure is not so limited. The overall circuit can be rotated 180 degrees so that up becomes down, rotated 90 degrees so that up becomes rightward, or can be rotated by any other amount.

In one configuration, an apparatus for reducing area on a memory interface includes means for receiving a first client select signal identifying a first client selectively coupled to the memory interface, means for coupling the first client to a first path in response to the first client select signal and means for propagating the first client select signal to a first set of tri-state buffers between the first client and a second client on the first path. The apparatus also includes means for turning on the first set of tri-state buffers in response to the first client select signal so that the first set of tri-state buffers couples the first client and the second client.

According to an aspect of the present disclosure, the apparatus may also include means for turning off a second set of tri-state buffers on the first path in response to the first client select signal so that the second set of tri-state buffers decouples segments of the first path that are not between the first client and the second client. According to another aspect of the present disclosure, the apparatus may also include means for tri-stating a second set of tri-state buffers on the first path in response to the first client select signal so that the second set of tri-state buffers drive segments of the first path that are not between the first client and the second client in their previous state.

The means for receiving a first client select signal identifying a first client selectively coupled to the memory interface may be the client selector multiplexors 216A-216D, for example. The means for coupling the first client to a first path in response to the first client select signal may be the write buffer 206 and/or the read buffer 208, for example. The means for propagating the first client select signal to a first set of tri-state buffers between the first client and a second client on the first path and the means for turning on the first set of tri-state buffers in response to the first client select signal may be the control circuitry 222 coupled to the source branch tri-state buffers 220A-220D and the pairs of oppositely directed ones of the tri-state buffers 212, 214, for example. The means for turning off a second set of tri-state buffers on the first path in response to the first client select signal and/or the means for tri-stating a second set of tri-state buffers on the first path in response to the first client select signal may be the control circuitry 222 coupled to the source branch tri-state buffers 220A-220D and the pairs of oppositely directed tri-state buffers 212, 214, for example. Although specific means have been set forth, it will be appreciated by those skilled in the art that not all of the disclosed means are required to practice the disclosed configurations. Moreover, certain well known means have not been described, to maintain focus on the disclosure.

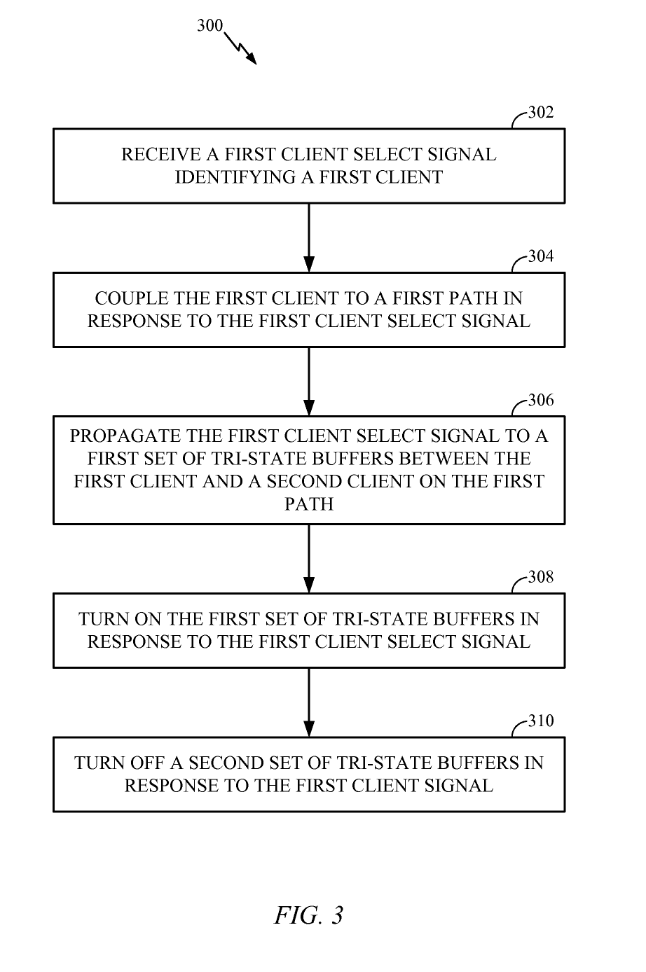

A method 300 for operating a memory interface according to an aspect of the present disclosure is described with reference to FIG. 3. In block 302, the method includes receiving a first client select signal identifying a first client selectively coupled to the memory interface. In block 304, the method includes coupling the first client to a first path in response to the first client select signal. In block 306, the method includes propagating the first client select signal to a first set of tri-state buffers between the first client and a second client on the first path. In block 308, the method includes turning on the first set of tri-state buffers in response to the first client select signal so that the first set of tri-state buffers couples the first client and the second client. In block 310, the method includes turning off a second set of tri-state buffers on the first path in response to the first client select signal so that the second set of tri-state buffers decoupling segments of the first path that are not between the first client and the second client.

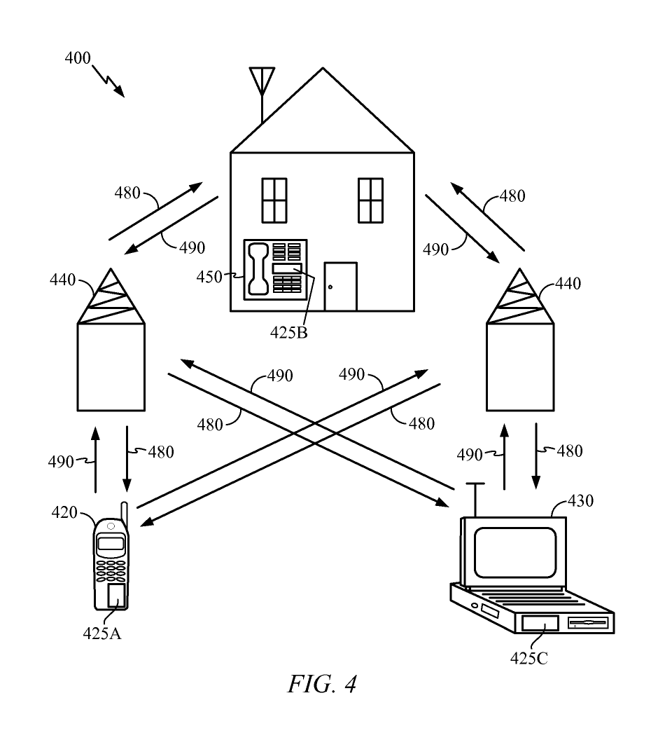

FIG. 4 shows an exemplary wireless communication system 400 in which a configuration of the disclosed interconnect circuitry may be advantageously employed. For purposes of illustration, FIG. 4 shows three remote units 420, 430, and 450 and two base stations 440. It will be recognized that wireless communication systems may have many more remote units and base stations. Remote units 420, 430, and 450 include the interconnect circuitry 425A, 425B, and 425C, respectively. FIG. 4 shows forward link signals 480 from the base stations 440 and the remote units 420, 430, and 450 and reverse link signals 490 from the remote units 420, 430, and 450 to base stations 440.

In FIG. 4, the remote unit 420 is shown as a mobile telephone, remote unit 430 is shown as a portable computer, and remote unit 450 is shown as a fixed location remote unit in a wireless local loop system. For example, the remote units may be cell phones, hand-held personal communication systems (PCS) units, portable data units such as personal data assistants, or fixed location data units such as meter reading equipment. Although FIG. 4 illustrates remote units, which may employ interconnect circuitry according to the teachings of the disclosure, the disclosure is not limited to these exemplary illustrated units. For instance, interconnect circuitry according to configurations of the present disclosure may be suitably employed in any device.

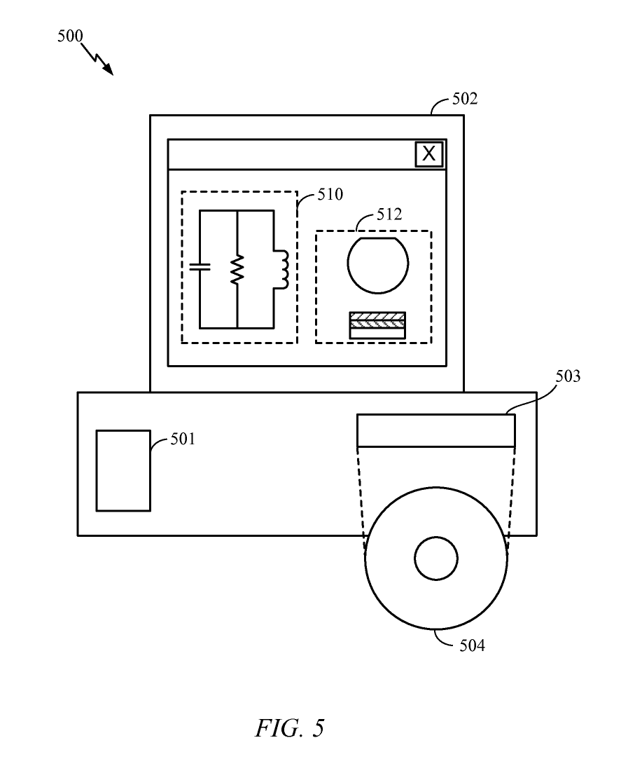

FIG. 5 is a block diagram illustrating a design workstation used for circuit, layout, and logic design of chip circuitry, such as the interconnect circuitry disclosed above. A design workstation 500 includes a hard disk 501 containing operating system software, support files, and design software such as Cadence or OrCAD. The design workstation 500 also includes a display 502 to facilitate design of a circuit design 510 or a semiconductor component design 512, such as the interconnect circuitry. A storage medium 504 is provided for tangibly storing the circuit design 510 or the semiconductor component design 512. The circuit design 510 or the semiconductor component design 512 may be stored on the storage medium 504 in a file format such as GDSII or GERBER. The storage medium 504 may be a CD-ROM, DVD, hard disk, flash memory, or other appropriate device. Furthermore, the design workstation 500 includes a drive apparatus 503 for accepting input from or writing output to the storage medium 504.

Data recorded on the storage medium 504 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 504 facilitates the design of the circuit design 510 or the semiconductor component design 512 by decreasing the number of processes for designing semiconductor wafers.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular configurations of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A low-power interconnect, comprising:
a plurality of paths coupling a plurality of selectable destination clients and a plurality of source clients, a number of the plurality of paths corresponding to a minimum of the number of the plurality of selectable destination clients and the number of the plurality of source clients;
a plurality of tri-state devices coupled between the source clients and the plurality of paths and configured to selectively allow data from the source clients onto the plurality of paths; and
control circuitry coupled to the plurality of tri-state devices, the control circuitry configured to control the plurality tri-state devices to establish connections between the destination clients and the source clients via the plurality of paths.

2. The low-power interconnect of claim 1, in which each of the tri-state devices is further configured to map a path between one of the plurality of source clients and one of the plurality of destination clients.

3. A memory interconnect, comprising:
a first path coupled between a plurality of selectable data sources and a first client;
a plurality of tri-state buffers configured in the first path between the plurality of selectable data sources; and
control circuitry coupled to the plurality of tri-state buffers, the plurality of tri-state buffers configured to couple selected portions of the first path between selected data sources of the plurality of selectable data sources in response to a control signal from the control circuitry.

4. The memory interconnect of claim 3, in which the plurality of tri-state buffers are further configured to gate off non-selected portions of the first path.

5. The memory interconnect of claim 3, in which the plurality of tri-state buffers are further configured to drive non-selected portions of the first path in a previous state of the non-selected portions.

6. The memory interconnect of claim 3, further comprising multiplexor circuitry coupled in the first path between the plurality of selectable data sources, the multiplexor circuitry further coupled to the control circuitry and configured to couple a selected data source to the selected portions of the first path in response the control signal.

7. The memory interconnect of claim 3, further comprising:
a number of selectable clients including the first client coupled to a number of selectable data sources including the plurality of selectable data sources via a number of paths including the first path, in which the number of paths is based on a lesser of the number of selectable clients and the number of selectable data sources.

8. The memory interconnect of claim 7, in which the number of paths comprises an XBAR architecture.

9. A method for operating a memory interface, comprising:
receiving a first client select signal identifying a first client selectively coupled to the memory interface;
coupling the first client to a first path in response to the first client select signal;
propagating the first client select signal to a first set of tri-state buffers between the first client and a second client on the first path; and
turning on the first set of tri-state buffers in response to the first client select signal, the first set of tri-state buffers coupling the first client and the second client.

10. The method of claim 9, further comprising:
turning off a second set of tri-state buffers on the first path in response to the first client select signal; and
decoupling, by the second set of tri-state buffers, segments of the first path that are not between the first client and the second client.

11. The method of claim 9, further comprising:
setting a second set of tri-state buffers on the first path to a bus-keeper state in response to the first client select signal; and
driving, by the second set of tri-state buffers, segments of the first path that are not between the first client and the second client in their previous state.
